(19) United States
(12) Patent Application Publication
(10) Pub. No.: US 2011/0060945 A1
(43) Pub. Date: Mar. 10, 2011

(54) SMART REPAIR OF COMPUTER SYSTEMS

(75) Inventors: Guillaume Leprince, Lallaing (FR); Bertrand Jaslet, Mouilleron le Captif (FR); Thierrv Lenepveu, Lyon (FR); Christian Leman, Austin, TX (US)

(73) Assignee: SOFTTHINKS SAS, Villeneuve d'Ascq (FR)

(21) Appl. No.: 12/768,595

(22) Filed: Apr. 27, 2010

Related U.S. Application Data
(60) Provisional application No. 61/240,566, filed on Sep. 8, 2009.

(51) Int. Cl. G06F 11/26; G06F 15/177

(52) U.S. Cl. 714/25; 713/1; 717/174; 714/E11.159

(57) ABSTRACT

A method and system for performing a smart repair of a target device is initiated by establishing a connection to a smart repair processing system. System components on the target device may then be analyzed, followed by an analysis of system software and user data. The target device user data may be secured by transfer to a backup server. A smart repair script may be generated based on user input and the results of the analysis. The smart repair script may then be executed on a secondary operating system loaded on the target device to attain a desired system configuration of the target device. The target device user data may then be restored on the target device.

### BACKGROUND

1. Field of the Disclosure

The present disclosure relates to the remediation of computer systems and, more particularly, to smart repair of target devices.

2. Description of the Related Art

After a computer system has been purchased and put in service by a user, certain defects may arise that adversely affect the continued operation and/or usability of the computer system. The defects may involve hardware components, operating system (OS) data, and/or application software data stored on the computer system and may be the result of a variety of causes, including malicious code, normal wear and tear, inadvertent actions, faulty data, and hardware malfunctions, among others. Common remediation methods for correcting the defects may restore the computer system to a prior state, but may force the user manually to perform time-consuming and complex operations to remediate the defects.

### BRIEF DESCRIPTION OF THE DRAWINGS

FIG. 1 is a block diagram of selected elements of an embodiment of a smart repair system;

FIG. 2 is a block diagram of selected elements of a second embodiment of a smart repair system;

FIG. 3 is a block diagram of selected elements of an embodiment of a smart repair administrator;

FIG. 4 is a block diagram of selected elements of an embodiment of a smart repair system sharing additional detail for one configuration information sources;

FIG. 5 is a block diagram of selected elements of an embodiment of a backup system;

FIG. 6 is a flow diagram of selected elements of an embodiment of a smart repair method;

FIG. 7 is a flow diagram detailing selected elements of the embodiment of the smart repair method of FIG. 6;

FIG. 8 is a flow diagram detailing selected elements of the embodiment of the smart repair method of FIG. 6;

FIG. 9 is a flow diagram detailing selected elements of the embodiment of the smart repair method of FIG. 6;

FIG. 10 is a flow diagram detailing selected elements of the embodiment of the smart repair method of FIG. 6;

FIG. 11 is a flow diagram detailing selected elements of the embodiment of the smart repair method of FIG. 6;

FIG. 12 is a flow diagram detailing selected elements of the embodiment of the smart repair method of FIG. 6;

FIG. 13 is a block diagram of selected elements of an embodiment of a computing device;

FIG. 14 is a block diagram of selected elements of an embodiment of a target device; and

FIG. 15 is a flow diagram of selected elements of an embodiment of a smart repair method.

### DESCRIPTION OF THE EMBODIMENT(S)

Computer systems are typically delivered in a usable configuration, including an OS and, optionally, application software. As used herein, a given “configuration” of a computer system refers to a particular state of the computer system, including specific hardware components and data stored on the computer system. A computer system may thus be preloaded with “system data,” which as referred to herein includes OS data and application software data. As used herein, “user data” represents data stored on the computer system that has been generated by the user. After the computer system has been subjected to normal usage by a user, user data may accumulate on the computer system. The user data may be specific to the user, and, for example, may include private data owned by the user. Other examples of user data may include passwords, views, preferences, default settings, application parameters, or combinations thereof. The user data may be in the form of data files, database entries, registry entries, or other types of data.

When a defect arises on the computer system, usability of the computer system for its intended purpose may be adversely affected. Defects may be related to a failure or malfunction of a hardware component. Defects in a computer system may also result from damaged or corrupted data, including OS data and application software data. Software data defects may result from malicious code, inadvertent actions, conflicts between different software applications, errors with component drivers, design of application software, and changing software environments and standards, among other causes.

In certain instances, the user is not able to ascertain the precise cause of the defect, and must perform (or obtain) support services to address the defect or otherwise remediate the computer system. This situation may present numerous disadvantages for the user. The support services associated with addressing the defect may be time-consuming, complex, unreliable, expensive, and/or difficult to obtain. In certain cases, the user may need to use a working computer system to obtain information or system data to remediate the defective computer system, which may involve accessing additional computing resources. Even when support services are available, the available remediation method may involve disruption of the user's desired configuration. In particular, remediation that involves restoring a previous configuration, such as an originally delivered configuration, may result in the loss of valuable user data that has accumulated on the computer system.

In certain situations, remediation by restoring a previous configuration is not desirable or may not be possible. For example, a supplier of an OS may have released a number of security updates to the OS since the previous configuration, such that a prior state of the OS is no longer considered secure or safe for use, even temporarily. In many cases, the user may rely upon additional application software, also referred to herein as application programs, which were installed after the previous configuration. The user data on the computer system may be dependent on the application program(s), without which the computer system may have little value to the user.

Furthermore, the marketplace for both hardware and software may have substantially changed since the computer system was originally purchased. Even if a defect in a hardware component is identified, an exact replacement may no longer be commercially available, which may, in turn, lead to the installation of a new hardware component and corresponding component drivers. The short product lifetime cycles of many types of application program(s) and OSs may result in a situation where the restoration of a previous configuration is no longer a viable option. Thus, remediation may involve attaining a new desired configuration, including certain upgrades or updates, which may, in turn, involve obtaining additional software licenses. The user may still further desire voluntarily to purchase a new application program or upgrade an existing application program at the time the remediation is performed, which may be a convenient way to attain a desired computer system configuration.

Thus, the problem of remediating a defective computer system involves many interrelated decisions and often includes a focus on user-specific issues. As described herein, a novel method of remediating a computer system is referred to as “smart repair” of a “target device.” Various embodiments of a disclosed smart repair system and method for remediating defects and/or for attaining a desired configuration on a target device are described herein.

In one aspect, a disclosed method for performing a smart repair of a target device may include establishing a communication link with the target device, where the communication link may be associated with a user of the target device. The method may further include analyzing system components included in the target device to generate target device status information, analyzing system software installed on the target device to generate system software status information. The system software may include a primary operating system (OS) loaded on the target device. Based on at least one of the target device status information and the system software status information, the method may further include populating a smart repair script specific to the target device with instructions executable to attain a desired configuration of the target device, and attaining the desired configuration of the target device by causing the target device to execute the smart repair script. The smart repair script may be executable under a secondary OS different from the primary OS.

In some embodiments, the method may further include securing user data stored on the target device, and, after said attaining the desired configuration of the target device, restoring the user data on the target device. The user data may include data generated by the user.

In certain embodiments, securing the user data may be performed via the communication link. After restoring the user data, the method may further include sending a confirmation to the target device that the desired configuration has been successfully attained, and terminating the communication link.

In particular embodiments, establishing the communication link may include detecting a connection with the target device, establishing communication with the target device, and determining an identity of the target device. Based on the identity, establishing the communication link may further include authenticating software licenses associated with the target device, sending target device code to the target device for execution by the target device, and communicating with the target device code executing on the target device. The target device code may be configured to access storage included in the target device.

In given embodiments, analyzing the system components may include identifying individual target device system components, testing the identified target device system components, and evaluating testing results to identify a defective target system component. Analyzing the system components may further include identifying defective component drivers and generating target device status information usable to populate the smart repair script, based on the method operation of evaluating the testing results and the method operation of identifying the component drivers. The smart repair script may include scripts for repairing, installing, upgrading, and reinstalling the identified component drivers, or a combination thereof.

In some embodiments, analyzing the system software may include identifying a primary OS installed on the target device, and testing primary OS data included in the primary OS and stored on the target device for a desired primary OS configuration. Based on the result of the primary OS data testing, analyzing the system software may further include identifying repair data for an existing application program previously installed on the target device, identifying installation data for a desired application program to be newly installed on the target device, and authenticating a target device software license for the desired application program. Analyzing the system software may still further include generating system software status information usable to populate the smart repair script, based on the primary OS remediation data, the repair data, the installation data and an authentication method.

In certain embodiments securing the user data may include identifying the user data stored on the target device, securing the identified user data by synchronizing the identified user data with backup user data, and generating user data status information usable to populate the smart repair script, based on the identified user data. When backup user data are available prior to securing the user data, the method may further include determining a difference between the identified user data and the backup user data, and securing the identified user data based on the difference.

In various embodiments, populating the smart repair script may include processing status information usable to populate the smart repair script. Executing the smart repair script may include remediating target device components, remediating component drivers associated with target device components, remediating an operating system previously installed on the target device, installing a new operating system on the target device, remediating application program(s) previously installed on the target device, and installing new application program(s) on the target device, or a combination thereof. Remediating may include repairing, installing, upgrading, and reinstalling, or a combination thereof. The method may yet further include obtaining system data from an external system software source. The system data may include component driver data, primary OS data, application software data, or a combination thereof. The external system software source may include a provider of target device components, component drivers, target devices, operating systems, application software, or a combination thereof.

In a further aspect, a disclosed smart repair processing system may include a processor configured to access memory media and a network adapter configured to connect to a target device. The memory media may include processor executable instructions to connect to the target device via the network adapter, analyze system components included in the target device, analyze system software installed on the target device, and receive user input indicative of a desired configuration of the target device. The system software may include a primary OS loaded on the target device. The memory media may further include processor executable instructions to attain a desired configuration of the target device, including processor instructions to execute a smart repair script specific to the target device. The smart repair script may be executable under a secondary OS on the target device, while the secondary OS is configured to access the primary OS.

In given embodiments of the smart repair processing system, the memory media may further include processor instructions executable to send code corresponding to the secondary OS to the target device, and, using the code sent to the target device, cause the secondary OS to be loaded on the target device. The memory media may further include processor instructions executable to send a query to the target device to determine whether the secondary OS is loaded on the target device, and, based on a result of the query, send the code corresponding to the secondary OS to the target device. The secondary OS may be a small footprint OS. The memory media may also include processor instructions executable to, prior to executing the smart repair script, secure user data stored on the target device, and restore the user data on the target device. The target device may include a wireless communications device. The network adapter may be configured to connect to the target device via a wireless network connection. The target device may be a mobile device. The processor and the network adapter may be included in a mobile device.

In certain embodiments of the smart repair processing system, the processor instructions to analyze the system components may include processor instructions executable to identify individual target device system components, test the identified target device system components, analyze testing results to identify a defective target system component, and identify component drivers for remediation, including repairing, installing, upgrading, and reinstalling the identified component drivers, or a combination thereof. The processor instructions to analyze the system components may further include processor instructions executable to send, to a smart repair server, target device status information usable to populate the smart repair script, based on the identified defective target device system components and the identified component drivers.

In some embodiments of the smart repair processing system, the processor instructions to analyze the system software may include processor instructions executable to identify the primary OS installed on the target device, including primary OS data stored on the target device, test the primary OS data for a desired primary OS configuration, and identify primary OS remediation data for attaining the desired primary OS configuration, based on the result of said testing the primary OS data. The processor instructions to analyze the system software may further include processor instructions executable to identify application software intended for the target device, identify repair data for an existing application program previously installed on the target device, identify installation data for a desired application program to be newly installed on the target device, and validate a target device software license for the desired application program. The processor instructions to analyze the system software may still further include processor instructions executable to send, to a smart repair server, system software status information usable to populate the smart repair script, based on the primary OS remediation data, the repair data, the installation data, and the target device software license.

In various embodiments of the smart repair processing system, the processor instructions to secure the user data may include processor instructions executable to identify the user data stored on the target device, secure the identified user data by synchronizing the identified user data with backup user data, and send, to a smart repair server, user data status information usable to populate the smart repair script, based on the identified user data.

In particular embodiments, when backup user data are available prior to securing the user data, the memory media may further include processor instructions executable to determine a difference between the identified user data and the backup user data and secure the identified user data based on the difference. The backup user data may be secured at a backup server.

In certain embodiments, the smart repair processing system may itself include the memory media. The memory media may further include processor executable instructions to receive the smart repair script from a smart repair server.

In yet another aspect, a disclosed computer-readable memory media may include computer executable instructions for smart repair processing. The instructions may be executable to identify system data associated with the target device in response to receiving an identity of a target device. The instructions may also be executable to receive target device status information describing target device components and component drivers associated with the target device, receive system software status information describing a primary OS and application software associated with the target device, and receive information describing a desired configuration for the target device. Based on at least one of the target device status information and the system software status information, the instructions may further be executable to populate a smart repair script executable to attain the desired configuration on the target device. The smart repair script may be executable under a secondary OS on the target device different from the primary OS.

In certain embodiments, the memory media may further include instructions executable to receive user data status information describing user data stored on the target device. The user data may include data generated by the user. The smart repair script may further include logical elements configured for conditional execution on the target device. The logical elements may include at least one of: logical evaluations, logical dependencies, test routines for the target device and associated test results, arithmetic evaluations, comparisons, execution branches, and execution loops.

In particular embodiments, the memory media may include instructions executable to receive an indication that the smart repair script was executed, including receiving an execution report for the executed smart repair script. The execution report may indicate that the smart repair script was successfully executed and that the desired configuration was attained on the target device. The memory media may also include instructions executable to receive user data from the target device, store the user data to a backup server, and after the smart repair script is executed on the target device, send the stored user data to the target device. The memory media may include instructions executable to execute the smart repair script using the secondary OS. The memory media may further include instructions executable to send the smart repair script to a kiosk application in communication with the target device.

In some embodiments, the memory media may include instructions executable to obtain the requested system data from an external system software source, in response to receiving a request for system data for the target device, and send the requested system data to the target device. The system data may include component driver data, operating system data, and application program data, or a combination thereof. The external system software source may include a provider of target device components, component drivers, target devices, operating systems, and application programs, or a combination thereof. The information describing the desired configuration may include an indication of system software for installation on the target device. The indicated system software may include a newly installed application program on the target device. The memory media may also include instructions executable to receive user data from the target device, receive system data from the target device, and store the user data and the system data on a backup server.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

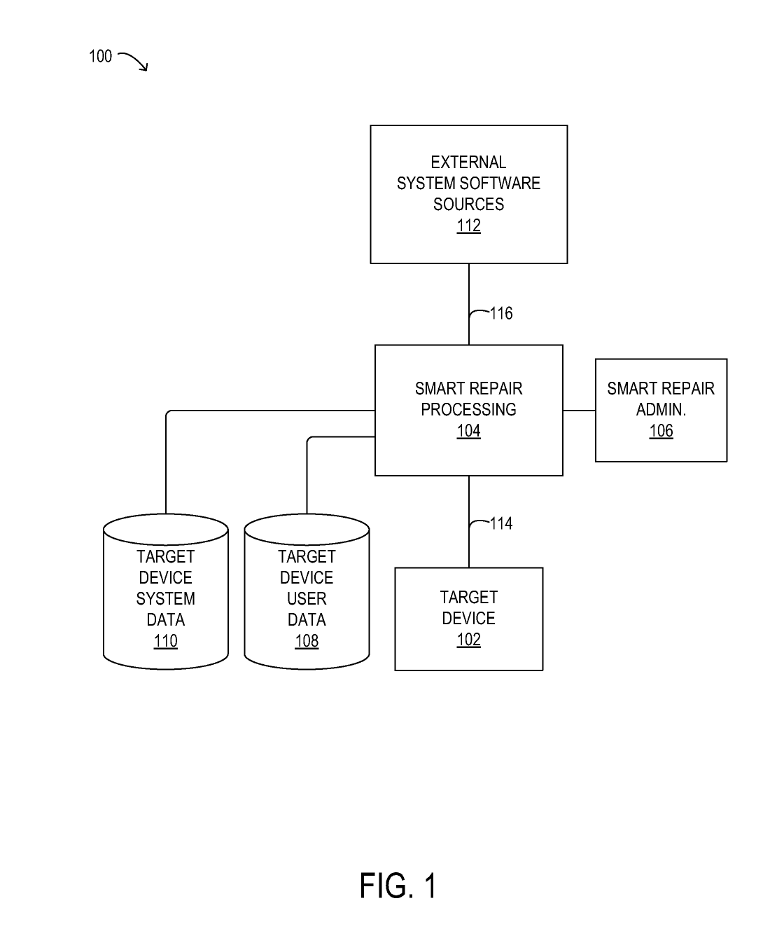

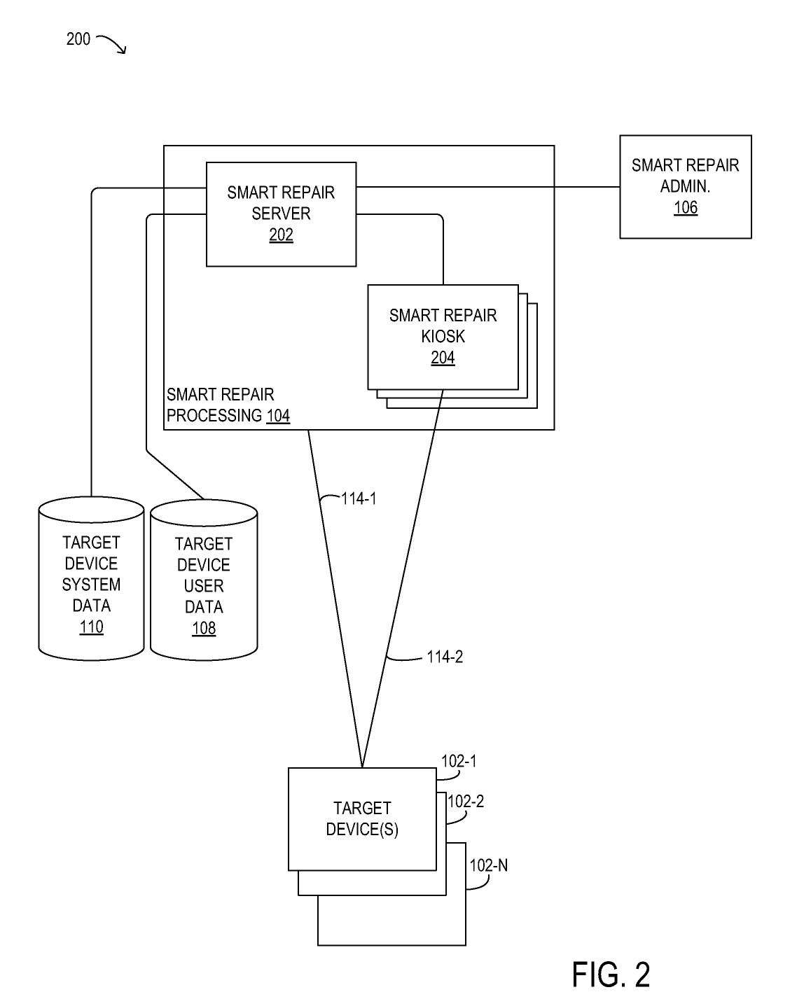

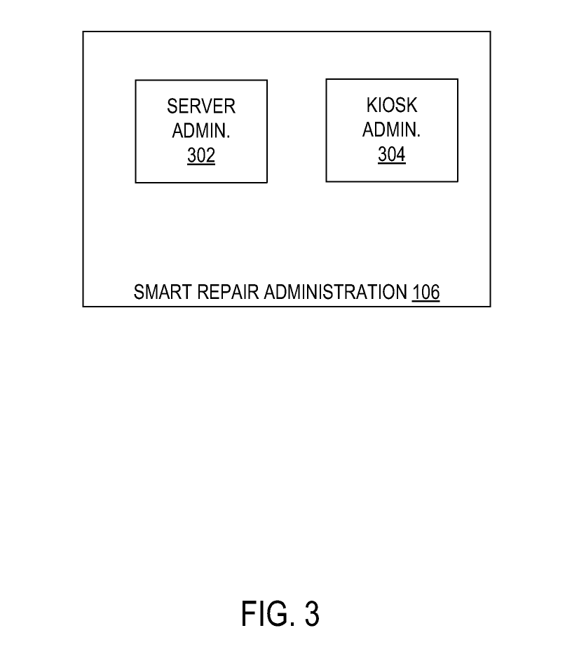

Referring now to FIG. 1, a block diagram of selected elements of an embodiment of smart repair system 100 is presented. Smart repair system 100 is depicted in generalized form for clarity. The depicted embodiment of smart repair system 100 includes smart repair processing 104, which represents infrastructure for interfacing with target device 102 and for performing smart repair operations on target device 102. It is noted that smart repair processing 104 may itself include various components and elements (see also FIG. 2) in different embodiments. In particular embodiments, smart repair processing 104 represents a network service provided by a service provider (not shown in FIG. 1). Also shown coupled to smart repair processing 104 is smart repair administration 106 (see also FIG. 3), which encompasses hardware and/or software functionality for administering and maintaining individual implementations of smart repair processing 104. In certain embodiments, one instance of smart repair administration 106 may be configured to service a plurality of instances of smart repair processing 104. Smart repair administration 106 may further be associated with a service provider offering smart repair processing 104 as a network service.

As shown in FIG. 1, target device 102 is coupled to smart repair processing 104 via communication link 114. Communication link 114 may employ any of a variety of interface connections, included fixed and/or wireless connections and local and/or remote connections. In embodiments wherein smart repair processing 104 is implemented as a physical installation, such as a walk-up kiosk system accessible to a user of target device 102, communication link 114 may represent a local-area network (LAN) connection between target device 102 and smart repair processing 104. Communication link 114 may also be a point-to-point interface, such as Universal Serial Bus (USB), IEEE 1398, or other bus interface. In other embodiments, communication link 114 may represent a wide-area network (WAN) connection between target device 102 and smart repair processing 104. In one example of WAN access, target device 102 accesses smart repair processing 104 via the Internet. Accordingly, communication link 114 may represent public and/or private network connections.

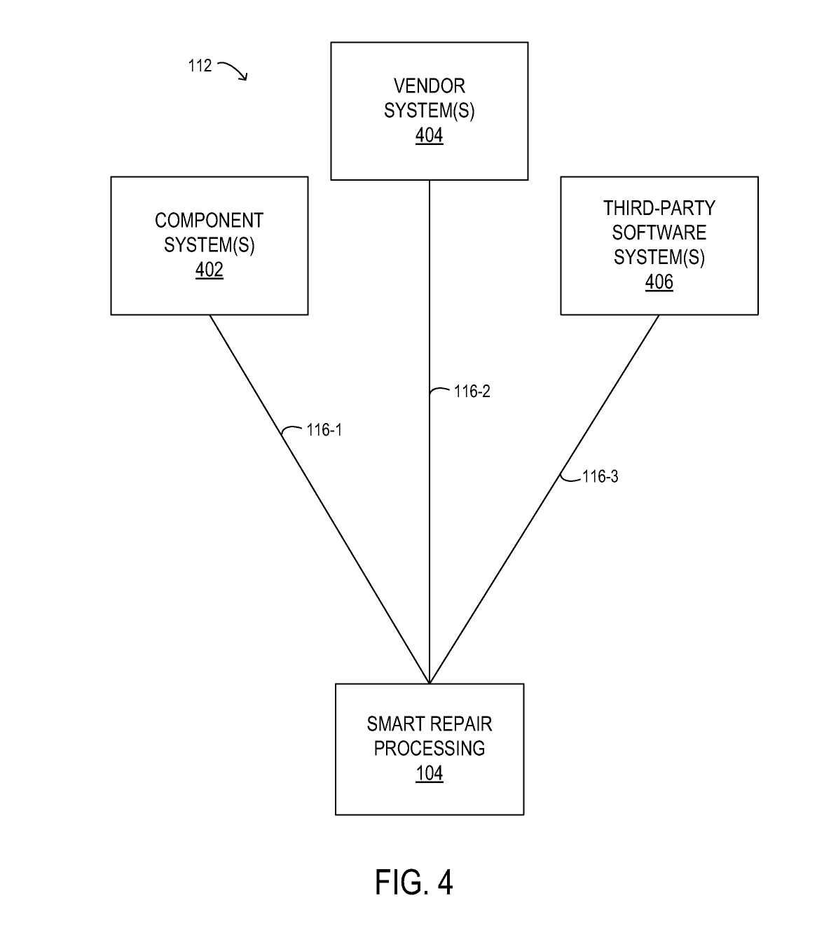

The depicted embodiment of smart repair system 100 includes external system software resources 112 (see also FIG. 4). External system software resources 112 may represent sources of system software and/or system data that are accessible to smart repair processing 104 for installation on target device 102. As will be described in detail below, smart repair processing 104 may access external system software resources 112 via communication link 116 to obtain certain system data, such as application software data, OS data, component driver data, and other types of data. Thus, external system software resources 112 may represent computer systems associated with external entities, such as vendors and/or suppliers of hardware and software, that provide download of system data via communication link 116. Communication link 116 may represent any of a variety of network connections, including fixed and/or wireless, local or wide-area connections.

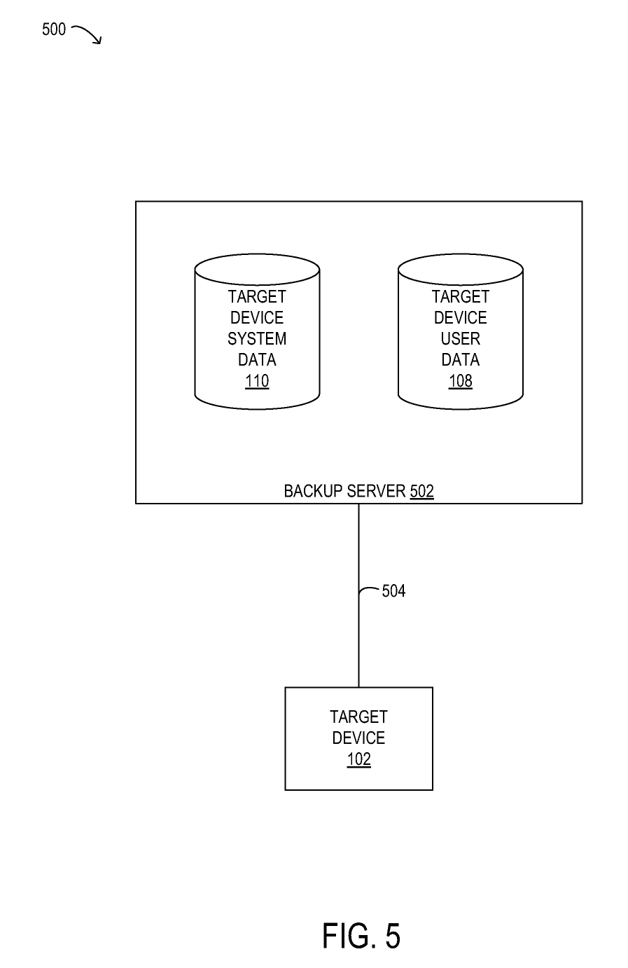

Further shown coupled to smart repair processing 104 in the embodiment of smart repair system 100 as depicted in FIG. 1 are target device system data 110 and target device user data 108. Both target device system data 110 and target device user data 108 may represent information repositories, such as database systems (see also FIG. 5), accessible to smart repair processing 104. The information stored in target device system data 110 and target device user data 108 may include information for a plurality of target devices, such as target device 102, while being indexed to individual target devices. In certain embodiments, target device system data 110 and target device user data 108 are included in smart repair processing 104 (not shown in FIG. 1). Target device system data 110 may provide storage of information associated with system data stored on target device 102, while target device user data 108 may provide storage of information associated with user data stored on target device 102. In certain embodiments, target device system data 110 includes system data stored on target device 102, while target device user data 108 includes user data stored on target device 102.

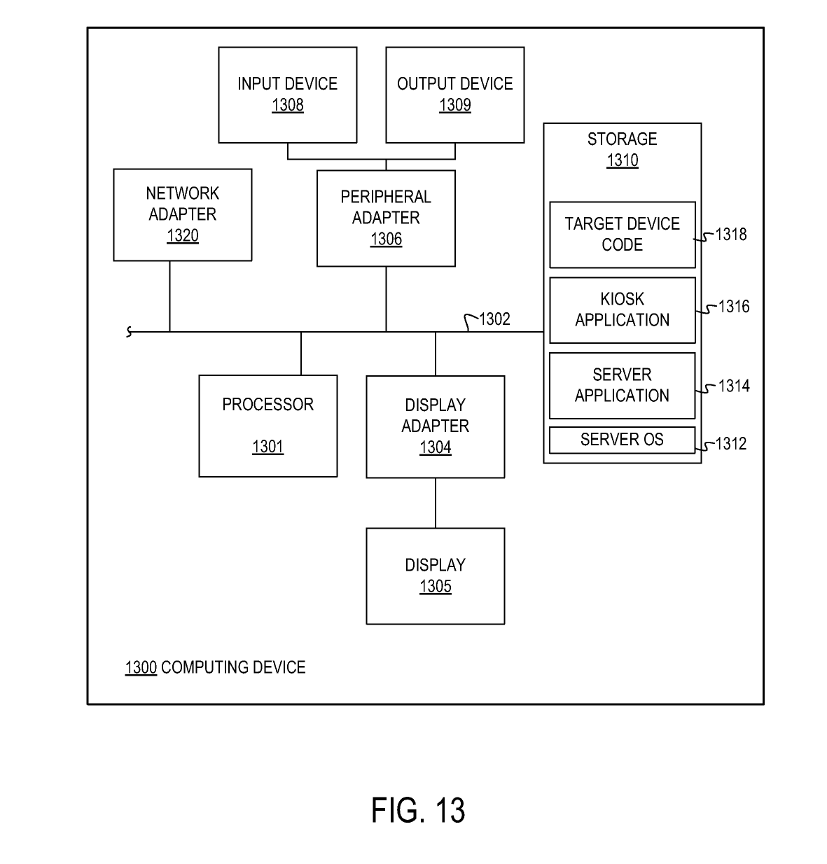

In operation, a user of target device 102 may connect target device 102 to smart repair processing 104 to attain a desired configuration of target device 102. The desired configuration may represent a configuration that corrects a defect present in target device 102. The desired configuration may also represent a configuration that includes additional system data, such as a new application program desired by the user. In one embodiment, a fixed network connection using a network cable is established between target device 102 and smart repair processing 104. Smart repair processing 104 may then detect a connection to target device 102 and may then proceed to identify target device 102. In certain embodiments, smart repair processing 104 may have previous knowledge of target device 102 or may be configured to obtain information about target device 102 from external system software resources 112. Smart repair processing 104 may then send target device code (see also FIG. 13) to target device 102, and then communicate with the target device code executing locally on target device 102. The target device code may execute under a separate (i.e., secondary) OS, which may be different than a primary OS loaded on target device 102. Smart repair processing 104 may then proceed to perform various analyses on target device 102, as will be described in detail herein. Based on the results of the analyses, along with input obtained by the user, smart repair processing 104 may then generate a smart repair script usable to attain the desired configuration of target device 102. Smart repair processing 104 may then cause the smart repair script to be executed with respect to target device 102, such that the desired configuration is attained on target device 102. The desired configuration may be attained for the primary OS loaded on target device 102. Once the desired configuration has been attained on target device 102, the remediation of target device 102 may be considered to have been successfully accomplished and target device 102 may be usable by the user for its intended purpose.

Turning now to FIG. 2, a block diagram of selected elements of an embodiment of smart repair system 200 is illustrated. In the depicted embodiment of smart repair system 200, smart repair processing 104 is shown in additional detail in FIG. 2 as an exemplary embodiment, as described above with respect to FIG. 1. Specifically, smart repair processing 104 is shown comprising smart repair server 202 coupled internally to a plurality of instances of smart repair kiosk 204, as will now be described in further detail.

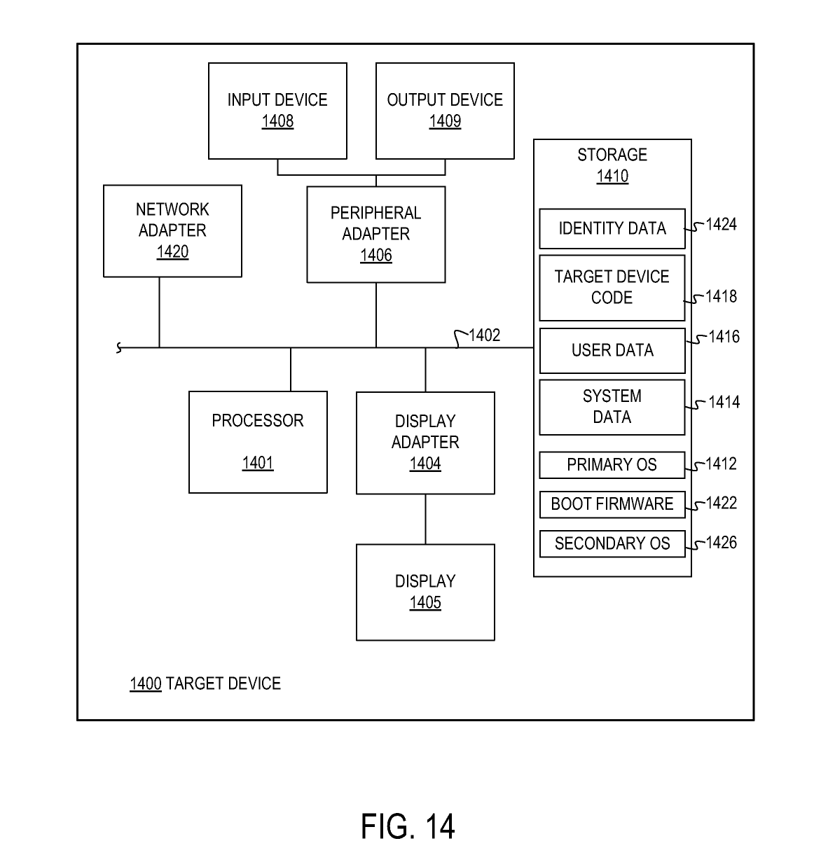

In addition, the embodiment depicted in FIG. 2 illustrates an implementation in which two or more target devices 102-1, 102-2, through 102-N, may be employed. Two target devices 102-1 and 102-2 may be employed, for example, when smart repair system 200 is used to replicate the “image” of a first target device 102-1 or portions of the image of the first target device on a second target device 102-2. In this context, the image of a target device encompasses all of the elements depicted in FIG. 14 (discussed in greater detail below) as being stored in storage 1410. Replication of a target device's image may be desirable when the user of first target device 102-1 upgrades or otherwise migrates to a second target device 102-2. In this case, the image created on the second device 102-2 may include the operating system(s), applications program(s), and/or user data that are stored on first target device 102-1. In other cases, the image created on second target device 102-2 may differ from the image of first target device 102-1. For example, a user may migrate from first target device 102-1 to second target device 102-2 where the second target device has an upgraded or otherwise distinct operating system from first target device 102-1. Similarly, it may be desirable or necessary to use a second target device 102-2 when the first target device 102-1 is damaged or is otherwise functionally compromised.

Additional target devices 102-N may be used or needed, for example, to create backup or redundant versions of second target device 102-2 or for various other reasons. Further, other embodiments, may replicate all or portions of the image of first target device 102-1 and all or portions of second target device 102-2 on a third target device 102-N. For example, a user who has two or more computers or other types of data processing devices, may employ smart repair system 200 to “merge” onto a single machine in the form of target device 102-N. In this embodiment, smart repair system 200 may merge the user data from first target device 102-1 and the user data from second target device 102-2 into the user data of the third target device 102-N.

In various embodiments, smart repair processing 104 may represent a network service provided via communication link 114. Accordingly, smart repair processing 104 may be embodied as a network server, including smart repair server 202, to which WAN communication link 114-1 may be established to target device 102. For example, target device 102 may connect via the Internet to a network address associated with smart repair processing 104, while smart repair server 202 and smart repair kiosk 204 may provide smart repair functionality to target device 102. In such an implementation, smart repair server 202 and smart repair kiosk 204 may represent application functionality provided by smart repair processing 104. For example, smart repair server 202 may provide back-end connectivity to target device system data 110 and target device user data 108 and may be accessible by smart repair administration 106. Smart repair kiosk 204 may represent application functionality provided via web pages to target device 102, such as a user interface for performing smart repair operations.

In particular embodiments, smart repair kiosk 204 may be implemented on a dedicated walk-up kiosk device that is accessible at a retail location to a user of target device 102. For example, several instances of smart repair kiosk 204 on respective dedicated hardware units may be installed within a consumer electronics store, providing service to users who bring their respective target device 102 for on-site smart repair. In another embodiment, smart repair kiosk 204 may be operated by users working at a facility for handling volume repairs, such as a repair center, a manufacturing facility, or a repair desk within a retail location. Smart repair kiosk 204 may access smart repair server 202, executing on a dedicated server, for back-end operations. For example, one instance of smart repair server 202 may be implemented at a retail location serving multiple instances of smart repair kiosk 204. In such a retail embodiment, communication link 114-2 may represent a physical fixed LAN connection, such as an Ethernet cable, between target device 102 and smart repair processing 104.

It is noted that various other embodiments and arrangements of implementing smart repair server 202 and smart repair kiosk 204 may be used with the methods described herein. For example, smart repair server 202 and/or smart repair kiosk 204 may be implemented on a mobile device and used at a location where target device 102 is installed. In such an example, communication link 116 (see FIG. 1) may represent a wireless connection. The mobile device may be a portable computer system, such as a laptop computer, a notebook computer, a tablet computer, or other similar device. The mobile device may, in certain instances, be a mobile communications device, such as a wireless telephony device providing additional computing resources (e.g., smart phone, personal digital assistant, etc.).

Advancing to FIG. 3, a block diagram of selected elements of an embodiment of smart repair administration 106 is illustrated. Specifically, smart repair administration 106 is shown including server administration 302 and kiosk administration 304. Server administration 302 may include services for installing and maintaining smart repair server 202 (see FIG. 2), while kiosk administration 304 may include services for installing and maintaining smart repair kiosk 204 (see FIG. 2). Smart repair administration 106 may provide administration for a plurality of installations of smart repair processing 104, including, but not limited to, obtaining performance metrics, billing operations, and software updates and upgrades.

Turning now to FIG. 4, a block diagram of selected elements of an embodiment of external system software resources 112 is illustrated. In FIG. 4, three examples of different types of external system software resources 112 are shown accessible to smart repair processing 104 via respective communication links 116.

In FIG. 4, component system(s) 402, accessible via communication link 116-1, may represent suppliers of components included in target device 102. For example, a main system board of target device 102 may include an integrated network controller, while component system(s) 402 represents a website of the manufacturer of the integrated network controller, from where product information, diagnostics, and component drivers may be accessible. Component system(s) 402 may also represent suppliers of software components, such as browser plug-ins or virtual drivers, included in target device 102.

Also in FIG. 4, vendor system(s) 404, accessible via communication link 116-2, may represent suppliers of target device 102 itself. Vendor system(s) 404 may include suppliers of an OS or application software delivered along with target device 102 Vendor system(s) 404 may provide product information, diagnostics, links to component system(s) 402, links to third-party software system(s) 406, along with component drivers, upgrades, and updates for target device 102. In various embodiments, vendor system(s) 404 represent web sites or network servers accessible to smart repair processing 104. Vendor system(s) 404 may further include sales databases, from which an original purchase order for target device 102 may be queried using an identifier for target device 102. In this manner, smart repair processing 104 may obtain sales and license information for authenticating instances of application program(s) and/or OSs for installation on target device 102.

Still further shown in FIG. 4 is third-party software system(s) 406, accessible via communication link 116-3. Third-party software system(s) 406 may represent suppliers of OSs and application software for installation on target device 102. In certain instances, third-party software system(s) 406 may themselves represent suppliers to vendor system(s) 404. Smart repair processing 104 may access third-party software system(s) 406 to obtain new software licenses and installation data, updates and upgrades for existing software licenses, or remediation data for defective application software data for installation on target device 102.

Continuing with FIG. 5, a block diagram of selected elements of an embodiment of backup system 500 is illustrated. Backup system 500, as shown, includes backup server 502, which may be coupled to target device 102 via communication link 504. Backup server 502 may include target device system data 110 and target device user data 108. Target device 102 may access backup server 502 to obtain backup services as a regularly scheduled service. That is, target device 102 may access backup server 502 when target device 102 is operating normally and no defect on target device 102 is observed. In this manner, target device system data 110 and target device user data 108 may be stored by backup server 502, which may then make target device system data 110 and target device user data 108 available to smart repair processing 104 in the event that target device 102 is presented for smart repair. Communication link 504 may represent an Internet connection, or other type of network connection, between target device 102 and backup server 502.

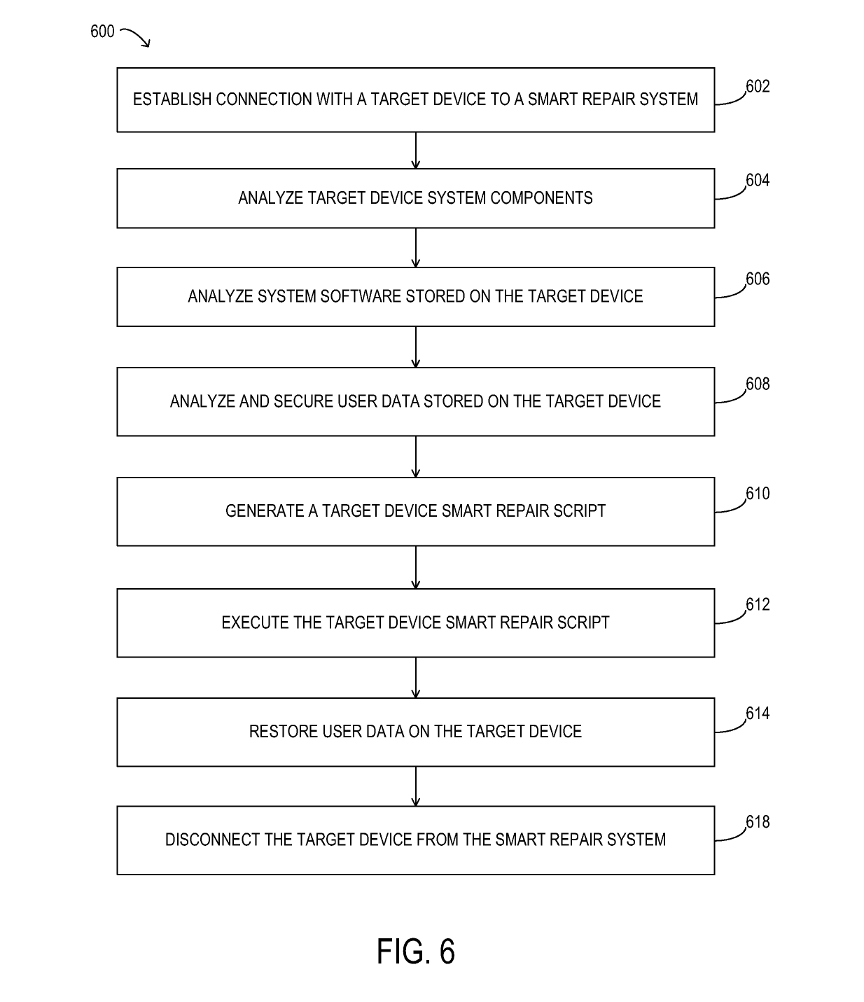

Advancing now to FIG. 6, a diagram of selected elements of one embodiment of smart repair method 600 is illustrated in flow chart form. Smart repair method 600 may be executed by smart repair processing 104 (see FIG. 1). In various embodiments, operations in smart repair method 600 may be omitted, repeated, or rearranged, as desired.

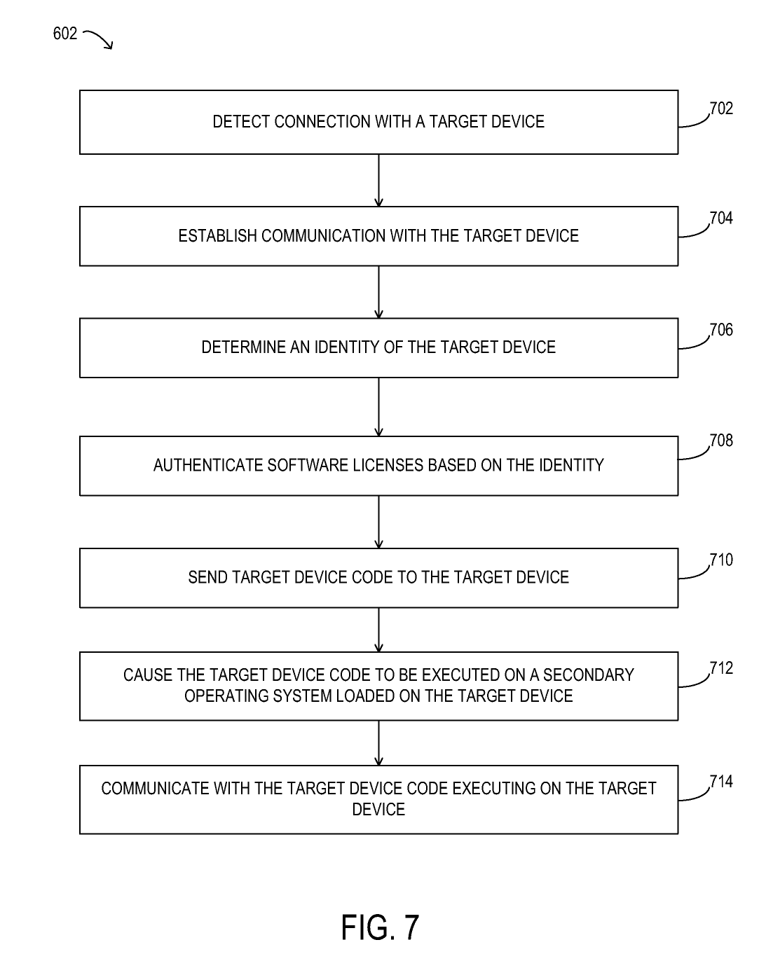

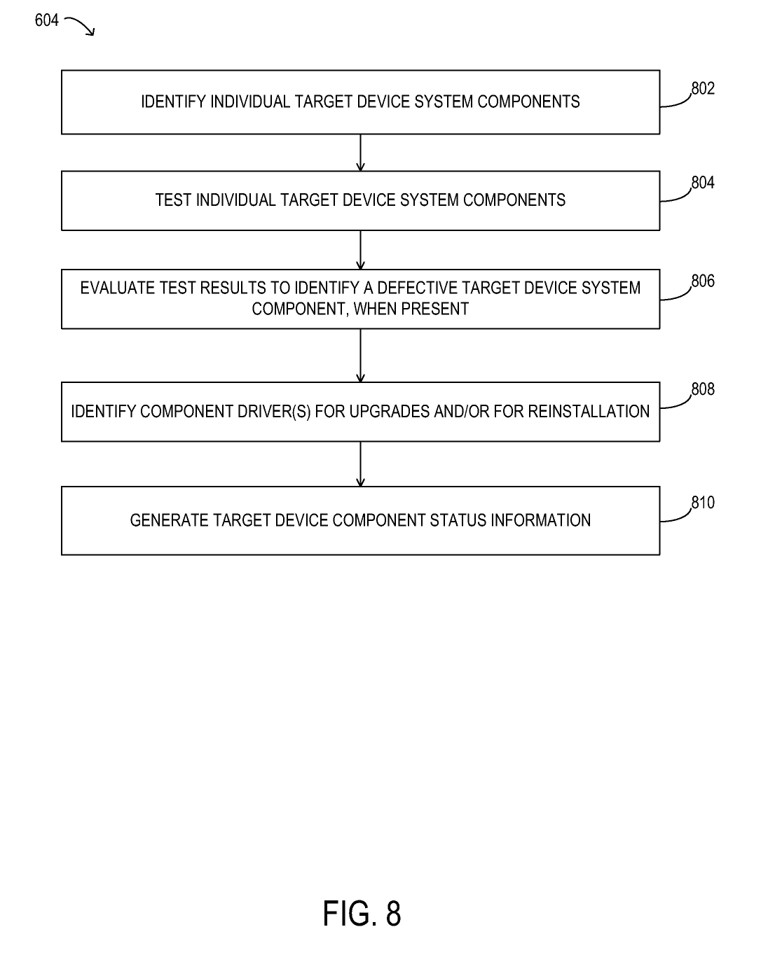

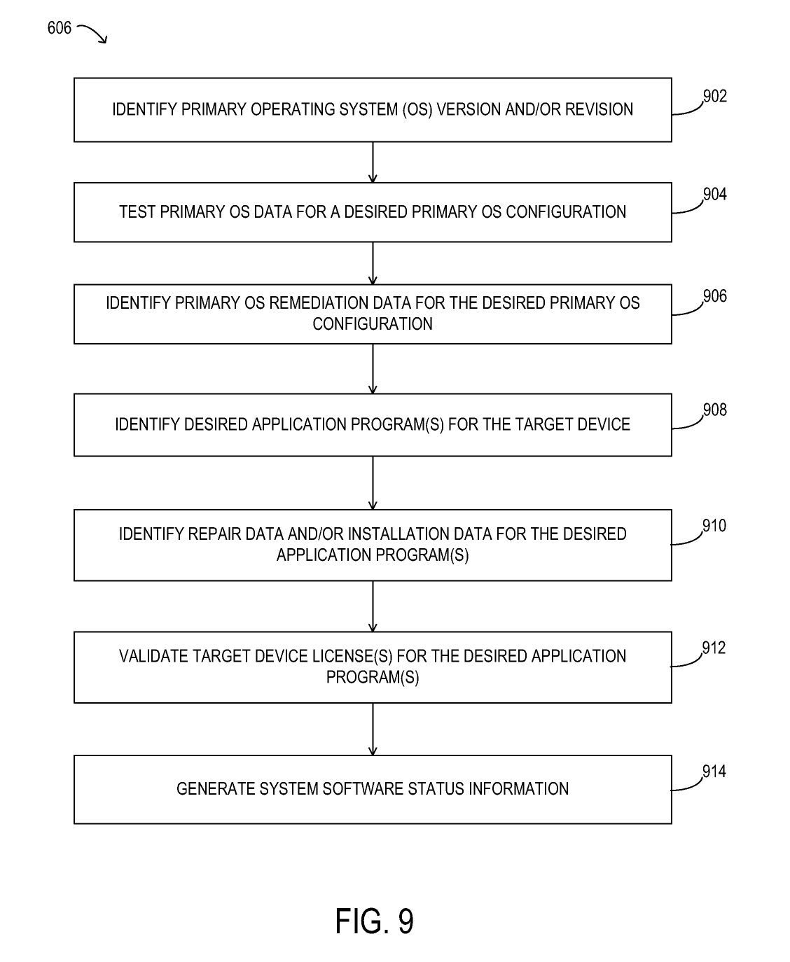

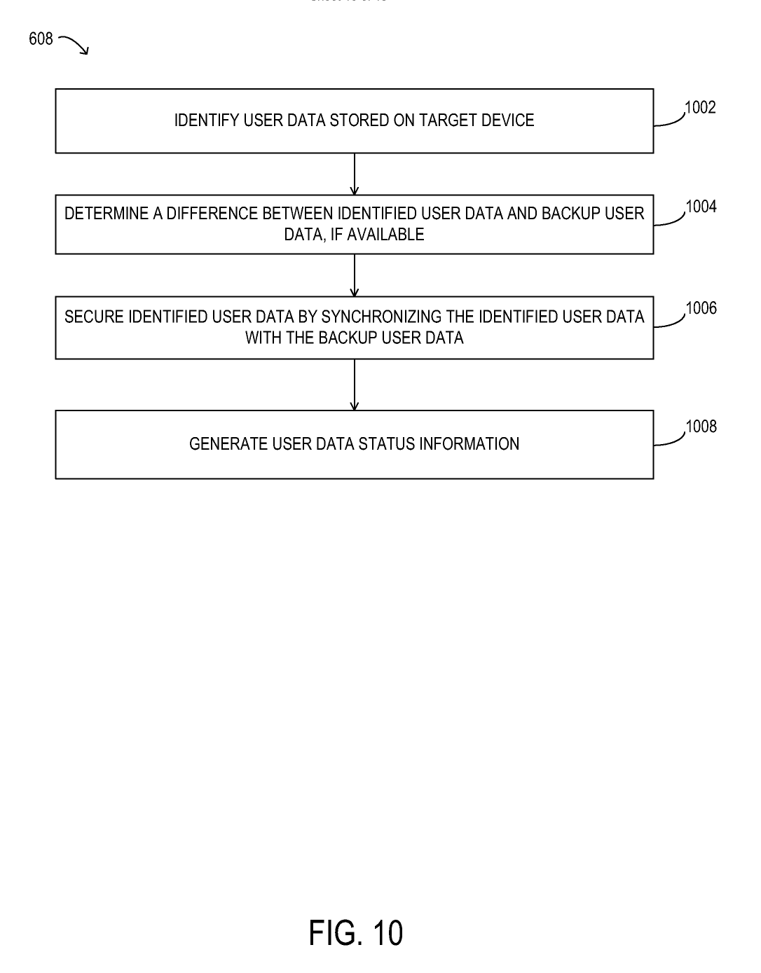

In the embodiment depicted in FIG. 6, a connection may be established with a target device to a smart repair system (operation 602). The connection may be established after the target device is physically connected to a network port of the smart repair system (see also FIG. 7). In certain embodiments, the connection may be a wireless network connection, for example, when target device is a mobile telephony device. After the connection is established, communication with the target device may occur. Target device system components may be analyzed (operation 604). Target device system components may include hardware components and sub-systems included in the target device. Analyzing target device system components may include performing hardware diagnostics on the target device (see also FIG. 8). System software stored on the target device may be analyzed (operation 606). The system software may include an OS and application software (see also FIG. 9). User data stored on the target device may be analyzed and secured (operation 608). Securing the user data may involve creating a backup copy of the user data on a backup server (see also FIG. 10). In particular embodiments, smart repair method 600 may omit operation 608 and proceed without securing user data.

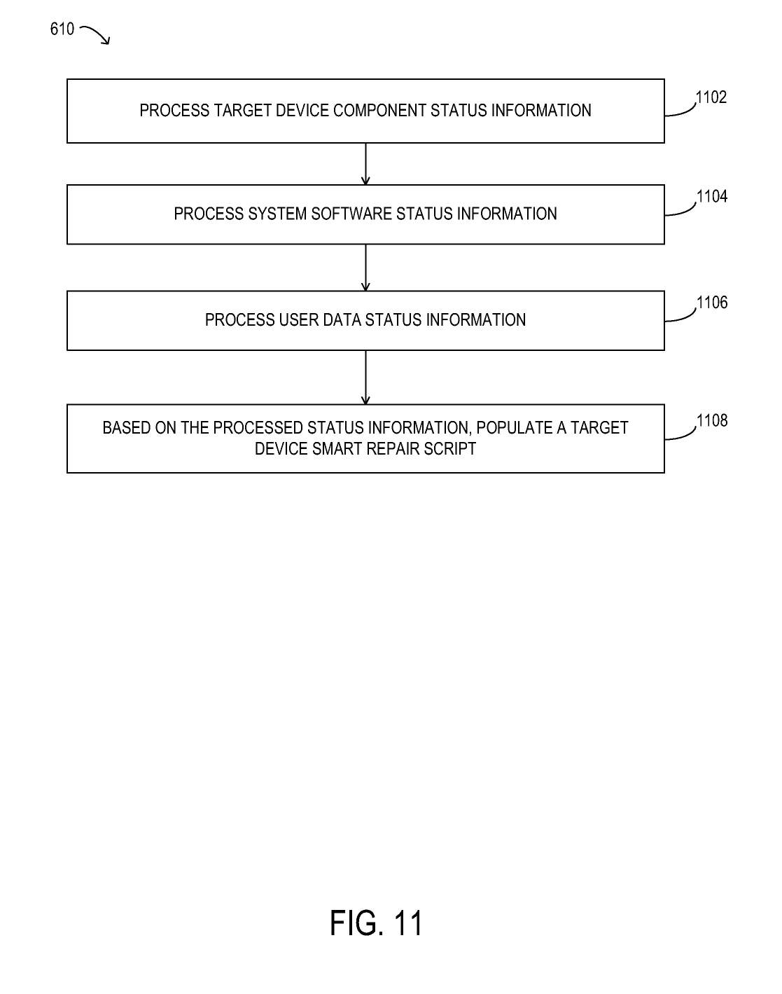

Next, a target device smart repair script may be generated (operation 610). The target device smart repair script may be usable to attain a desired configuration on the target device (see also FIG. 11). It is noted that the target device smart repair script may be specific to the target device connected to the smart repair system in operation 602, and include instructions based on the analyses performed in operations 604 and 606. It is further noted that the target device smart repair script my further include logical instructions or elements configured for conditional execution. For example, the target device smart repair script may perform tests on the target system and generate test results. The test results, along with other information and parameters associated with the target system, may be used to conditionally execute certain portions of the target device smart repair script. The logical elements may further include logical evaluations, logical dependencies, arithmetic evaluations, comparisons, as well as branched execution structures and execution loops.

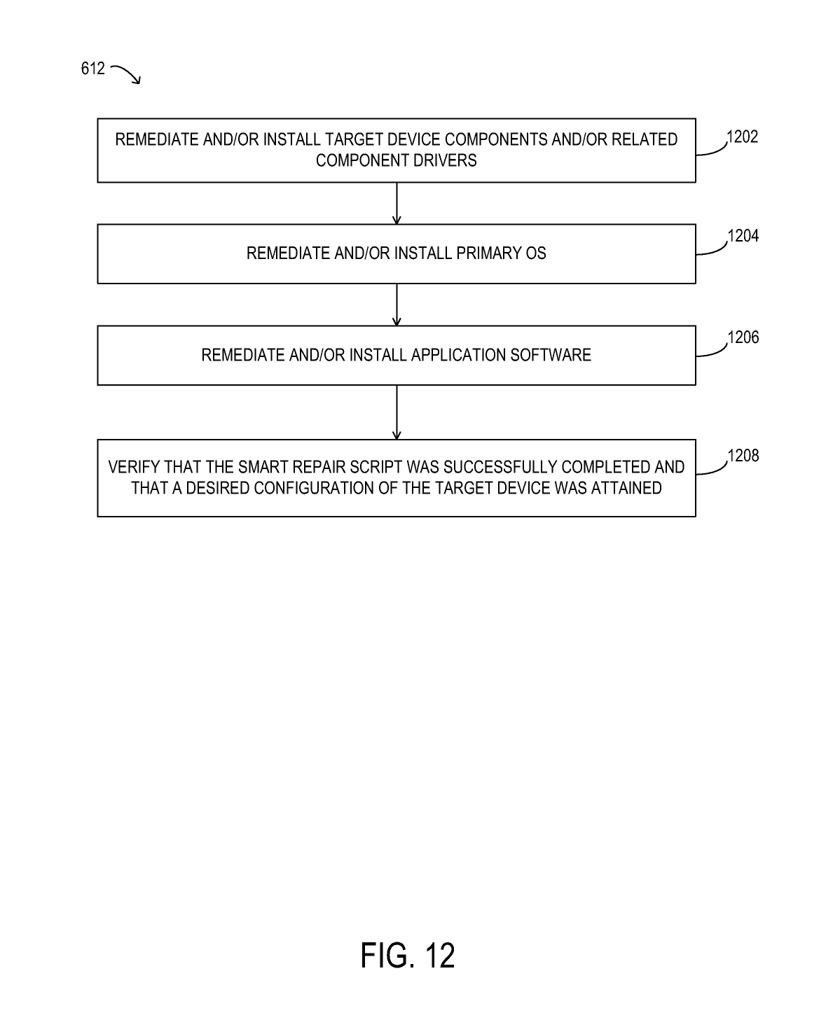

The target device smart repair script may then be executed (operation 612). The target device smart repair script may specify various remediation operations to be performed on the target device (see also FIG. 12). Execution of the target smart repair script may be performed under a secondary OS on the target device. The secondary OS may be configured to access a primary OS loaded on the target device, for performing smart repair of the primary OS and related data. The target device repair script may thus be sent to the target device for execution on the secondary OS. In certain instances, the secondary OS may also be sent to the target device, for example, after a determination has been made that a desirable version of the secondary OS is not loaded on the target device.

Then, the user data may be restored on the target device (operation 614). Restoration of the user data may include validating that the user data stored on the target device prior to performing a smart repair operation are still intact. In particular embodiments of smart repair method 600, such as when operation 608 is omitted, operation 614 may also be omitted. The target device may be disconnected from the smart repair system (operation 618). Disconnecting the target device may include notifying a user of the smart repair system to physically remove a connection to a network port of the smart repair system.

Advancing now to FIG. 7, a diagram of one detailed embodiment of smart repair method 602 is illustrated in flow chart form (see also FIG. 6). In various embodiments, operations in smart repair method 602 may be omitted, repeated, or rearranged, as desired.

In FIG. 7, a connection with a target device may be detected (operation 702). The connection may be detected at a network port of the smart repair system, when a physical connection to a network port of the target device has been established. A network protocol may be used to detect the connection, for example, an Ethernet network protocol. Communication may be established with the target device (operation 704). The communication may be between network ports connected during operation 702. The communication may include sending commands to the target device or causing commands to be executed on the target device. The communication may further include receiving information from the target device. An identity of the target device may be determined (operation 706). The identity may be a Media Access Control address (MAC address) of a network port included in the target device. The identity may also be a system tag or other identity data associated with the target device. The identity may be determined by reading identity data from a memory medium included in the target device. Software licenses may be authenticated based on the identity (operation 708). The identity may be used to obtain an original sales invoice or the like for the target device by contacting a vendor system of a supplier of the target device. The identity may also be used to directly determine software licenses registered to the target device. The software licenses may include a license for the primary OS loaded on the target device. Then, target device code may be sent to the target device (operation 710). The target device code may be caused to execute on a secondary OS loaded on the target device (operation 712). The target device code may be configured to receive commands, execute commands, and read data on the target device, as well as transmit data via the network port from the target device. Method 602 may then proceed to communicate with the target device code executing on the target device (operation 714). The target device code may further enable access to the primary OS from the secondary OS.

Referring now to FIG. 8, a diagram of one detailed embodiment of smart repair method 604 is illustrated in flow chart form (see also FIG. 6). In various embodiments, operations in smart repair method 604 may be omitted, repeated, or rearranged, as desired.

In FIG. 8, individual target device system components may be identified (operation 802). In one example, a firmware interface may be used to identify hardware system components on the target system. The firmware interface may be a boot firmware that is configured to boot the target device. In an exemplary embodiment, the firmware interface is a basic input/output system (BIOS). Individual target system components may be tested (operation 804). The testing may include executing a hardware diagnostic for the individual target system components identified in operation 802. The testing may generate test results, for example, a simple pass/fail diagnostic test result. In certain embodiments, testing in operation 804 may generate more detailed test results indicating a condition of the tested system component. Test results may be evaluated to identify a defective target device system component, when present (operation 806). When the test results do not indicate any system component failures, then no defective target device system component may be identified in operation 806. Component driver(s) for upgrades and/or for reinstallation may be identified (operation 808). A component driver may be identified in operation 808 in response to a test result evaluated in operation 806. Identifying a component driver may also include identifying a source for obtaining component driver data and information. The source for obtaining component driver data and information may be associated with a network address of a supplier of a component system (see also FIG. 4). Next, target device component status information may be generated (operation 810). The target device component status information may include information usable to populate a smart repair script for remediating target device system components of the target device. The target device component status information may thus include a plurality of executable commands for obtaining remediation data from external sources and installing the remediation data on the target device. The executable commands may be used to populate the smart repair script.

Turning now to FIG. 9, a diagram of one detailed embodiment of smart repair method 606 is illustrated in flow chart form (see also FIG. 6). In various embodiments, operations in smart repair method 606 may be omitted, repeated, or rearranged, as desired.

In FIG. 9, a primary OS version and/or revision may be identified (operation 902). Operation 902, along with other portions of method 606, may be repeated for each of a plurality of OSs installed on the target device. The primary OS version may further identify a vendor or supplier of the installed primary OS. Based on the primary OS version and/or revision, primary OS data stored on the target device may further be identified in operation 902. Primary OS data may be identified by communicating with the target device code to read the contents of a storage device included in the target device. The primary OS data may be tested for a desired primary OS configuration (operation 904). The desired configuration may be determined based on the identified primary OS in operation 902. The desired configuration may also be based on information received from a supplier of the primary OS at the smart repair system. The desired configuration may further be based on user input provided by a user of the target device. Primary OS remediation data for the desired primary OS configuration may be identified (operation 906). The primary OS remediation data may be identified based on testing results generated during operation 904. The testing results may include an indication of a difference between the actual primary OS data stored on the target device and the primary OS data associated with the desired configuration. The primary OS remediation data may provide remediation of the difference. Identifying the primary OS remediation data may include identifying a source from where at least portions of the primary OS remediation data may be obtained. Desired application program(s) may be identified (operation 908). The desired application program(s) may include a new application program that was not previously installed on the target device. The desired application program may further include a new version of a previously installed application program. The desired application program(s) may further indicate a previously installed application program that is to be remediated by the smart repair system. Repair data and/or installation data for the desired application program may be identified (operation 910). Identifying the repair data and/or installation data may include identifying a source for obtaining the data. Target device license(s) for the desired application program(s) may be validated (operation 912). The target device licenses may be validated by contacting a software vendor. Validating the license(s) may include purchasing a new license for a desired application program(s) in response to receiving a purchase request from the user. Next, system software status information may be generated (operation 914). The system software status information may include information usable to populate a smart repair script for remediating system software for the target device. The system software status information may thus include a plurality of executable commands for obtaining remediation data from external sources and installing the remediation data on the target device. The executable commands may be used to populate the smart repair script.

Referring now to FIG. 10, a diagram of selected elements of one detailed embodiment of smart repair method 608 is illustrated in flow chart form (see also FIG. 6). In various embodiments, operations in smart repair method 608 may be omitted, repeated, or rearranged, as desired.

User data stored on the target device may be identified (operation 1002). Identifying the user data may include identifying a storage location of the user data on the target device. A difference between identified user data and backup user data, if available, may be determined (operation 1004). If no backup user data is available, then the entire user data identified in operation 1002 may be identical to the difference identified in operation 1004. The backup user data may be accessed from a backup server. The identified user data may be secured by synchronizing the identified user data with the backup user data (operation 1006). Synchronizing may involve making a backup copy of the user data, or at least a portion of the user data corresponding to the difference identified in operation 1004. The backup copy may be created on a backup server. Next, user data status information may be generated (operation 1008). The user data status information may include information usable to populate a smart repair script for preserving user data on the target device. The user data status information may thus include a plurality of executable commands for backing up, and optionally restoring, user data on the target device. The executable commands may be used to populate the smart repair script.

Referring now to FIG. 11, a diagram of one detailed embodiment of smart repair method 610 is illustrated in flow chart form (see also FIG. 6). In various embodiments, operations in smart repair method 610 may be omitted, repeated, or rearranged, as desired.

Target device component status information may be processed (operation 1102). The target device component status information may be generated in operation 810 (see FIG. 8). System data status information may be processed (operation 1104). The system software status information may be generated in operation 914 (see FIG. 9). User data status information may be processed (operation 1106). The user data status information may be generated in operation 1008 (see FIG. 10). Based on the processed status information, a target device smart repair script may be populated (operation 1108). The smart repair script may be based on target component status information, system software status information, and user data status information, among other possible sources of status information. It is noted that in certain instances, certain status information may indicate that no executable commands are to be included in the smart repair script. For example, target component status information may indicate that the target device is operating normally (i.e., has a normal component configuration), and therefore, no remediation actions are indicated. Accordingly, the smart repair script may include the executable commands that are relevant to the desired configuration.

Referring now to FIG. 12, a diagram of one detailed embodiment of smart repair method 612 is illustrated in flow chart form (see also FIG. 6). In various embodiments, operations in smart repair method 612 may be omitted, repeated, or rearranged, as desired.

Target device components and/or related component drivers may be remediated and/or installed (operation 1202). When a target device component to be installed (or replaced) is a hardware component, the user may be instructed to performed the hardware installation (or replacement) on the target device. The primary OS may be remediated and/or installed (operation 1204). In certain embodiments, more than one primary OS may be loaded and used on the target device, such that operation 1204 may be repeated accordingly. Application software may be remediated and/or installed (operation 1206). Method 612 may then verify that the smart repair script was successfully completed and that a desired configuration of the target device was attained (operation 1208). A notification of the successful completion of the smart repair script may be sent or displayed to the user. In certain instances, the smart repair script may be executed without attaining the desired configuration, in which case a notification or an execution report of the results of executing the smart repair script may be generated.

Referring now to FIG. 13, a block diagram illustrating selected elements of an embodiment of computing device 1300 is presented. Computing device 1300 may represent various embodiments of smart repair processing 104 (see FIGS. 1 and 2).

In the embodiment depicted in FIG. 13, computing device 1300 includes processor 1301 coupled via shared bus 1302 to storage media collectively identified as storage 1310. Computing device 1300, as depicted in FIG. 13, further includes network adapter 1320 that interfaces computing device 1300 to a network (not shown in FIG. 13). In the embodiment depicted in FIG. 13, computing device 1300 may include peripheral adapter 1306, which provides connectivity for the use of input device 1308 and output device 1309. Input device 1308 may represent a device for user input, such as a keyboard or a mouse, or even a video camera. Output device 1309 may represent a device for providing signals or indications to a user, such as loudspeakers for generating audio signals.

Computing device 1300 is shown in FIG. 13 including display adapter 1304 and further includes a display device or, more simply, a display 1305. Display adapter 1304 may interface shared bus 1302, or another bus, with an output port for one or more displays, such as display 1305. Display 1305 may be implemented as a liquid crystal display screen, a computer monitor, a television or the like. Display 1305 may comply with a display standard for the corresponding type of display. Standards for computer monitors include standards such as Video Graphics Array (VGA), Extended Graphics Array (XGA), and related vector video standards, and may further encompass digital interface standards such as Digital Visual Interface (DVI), and High-Definition Multimedia Interface (HDMI), among others. A television display may comply with standards such as National Television System Committee (NTSC), Phase Alternating Line (PAL), or another suitable standard.

Display 1305 may include an output device 1309, such as one or more integrated speakers to play audio content, or may include an input device 1308, such as a microphone or video camera. In some embodiments, computing device 1300 may be configured without (i.e., may exclude) at least one of input device 1308, output device 1309, and display 1305.

Storage 1310 encompasses persistent and volatile memory media, fixed and removable memory media, and magnetic and semiconductor memory media. Storage 1310 is operable to store instructions, data, or both. Storage 1310 as shown includes sets or sequences of instructions, namely, server OS 1312, server application 1314, kiosk application 1316, and target device code 1318. Server OS 1312 may be a UNIX or UNIX-like OS, a Windows® family OS, or another suitable OS.

In certain embodiments, computing device 1300 may represent smart repair server 202 (see FIG. 2). For example, computing device 1300 may execute server application 1314 to provide back-end smart repair functionality, such as access to database servers, backup servers, and external system software sources 112 (see FIGS. 1 and 4). Computing device 1300 may also execute kiosk application 1316, for example, when target device 102 connects to smart repair processing 104 via communication link 114-1 (see FIG. 2). Computing device 1300 may alternatively send kiosk application 1316 to smart repair kiosk 204 for execution at smart repair kiosk 204, for example, when target device 102 connects to smart repair processing 104 via communication link 114-2 (see FIG. 2). Computing device 1300 may still further send target device code 1318 to target device 102 when a connection is established between target device 102 and smart repair system 100 (see also FIGS. 1 and 7).

Referring now to FIG. 14, a block diagram illustrating selected elements of an embodiment of target device 1400 is presented. Target device 1400 may represent various embodiments of target device 102 (see FIGS. 1 and 2), including desktop computers, laptop computers, handheld computing devices, netbooks, computing pads, tablet computers, as well as devices that further include wireless telephony features, such as cellular telephones, smart phones, personal digital assistants (PDA), among others.

In the embodiment depicted in FIG. 14, target device 1400 includes processor 1401 coupled via shared bus 1402 to storage media collectively identified as storage 1410. Target device 1400, as depicted in FIG. 14, further includes network adapter 1420 that interfaces target device 1400 to a network (not shown in FIG. 14). In certain embodiments, network adapter 1420 may further represent one or more wireless network adapters configured to connect to at least one wireless network (not shown in FIG. 14), such as wireless local area networks (LAN), wireless personal area networks (PAN), and wireless wide area networks (WAN), including cellular telephone networks.

In the embodiment depicted in FIG. 14, target device 1400 may include peripheral adapter 1406, which provides connectivity for the use of input device 1408 and output device 1409. Input device 1408 may represent a device for user input, such as a keyboard or a mouse, or even a video camera. Output device 1409 may represent a device for providing signals or indications to a user, such as loudspeakers for generating audio signals.

Target device 1400 is shown in FIG. 14 including display adapter 1404 and further includes a display device or, more simply, a display 1405. Display adapter 1404 may interface shared bus 1402, or another bus, with an output port for one or more displays, such as display 1405. Display 1405 may be implemented as a liquid crystal display screen, a computer monitor, a television or the like. Display 1405 may comply with a display standard for the corresponding type of display. Standards for computer monitors include standards such as VGA, XGA, and related vector video standards, and may further encompass digital interface standards such as DVI and HDMI, among others. A television display may comply with standards such as NTSC, PAL, or another suitable standard.

Display 1405 may include an output device 1409, such as one or more integrated speakers to play audio content, or may include an input device 1408, such as a microphone or video camera. In some embodiments, target device 1400 may be configured without (i.e., may exclude) at least one of input device 1408, output device 1409, and display 1405.

Storage 1410 encompasses persistent and volatile memory media, fixed and removable memory media, and magnetic and semiconductor memory media. It is noted that storage 1410 may include different individual storage elements (not shown in FIG. 14). Storage 1410 is operable to store instructions, data, or both. The instructions and/or data that storage 1410 contains may be referred to as the image of target device 102. Storage 1410 as shown includes sets or sequences of instructions, namely, secondary OS 1426, boot firmware 1422, primary OS 1412, system data 1414, user data 1416, target device code 1418, and identity data 1424. Boot firmware 1422 may be operable to boot target device 1400 and to provide access to network adapter 1420. In certain embodiments, boot firmware 1422 may further provide access to identity data 1424, which may represent unique identifiers for target device 1400 and may be stored in a non-volatile portion of storage 1410. Primary OS 1412 and/or secondary OS 1426 may be a UNIX or UNIX-like OS, a Windows® family OS, or another suitable OS. It is noted that secondary OS 1426 may be a “small footprint OS”, such as a highly compact OS or an embedded OS. Secondary OS 1426 may be suitable for transmission and installation over a network and may be executed using only available volatile memory (not explicitly shown in FIG. 14) on target device 1400. As noted previously, secondary OS 1426 may be configured to access primary OS 1412, in particular, for the purposes of smart repair of primary OS 1412, as described herein. It is noted that primary OS 1412 may represent a plurality of individual OSs in use on target device 1400. System data 1414 may represent OS data and application software data that are associated with a configuration of target device 1400. User data 1416 may represent data generated by a user of target device 1400. Target device code 1418 may be received by target device 1400 during smart repair and may be executed using processor 1401 for providing specialized functionality, including communicating with smart repair processing 104 (see FIGS. 1 and 2). For example, target device code 1418 may be executable to access system data 1414 and user data 1416.

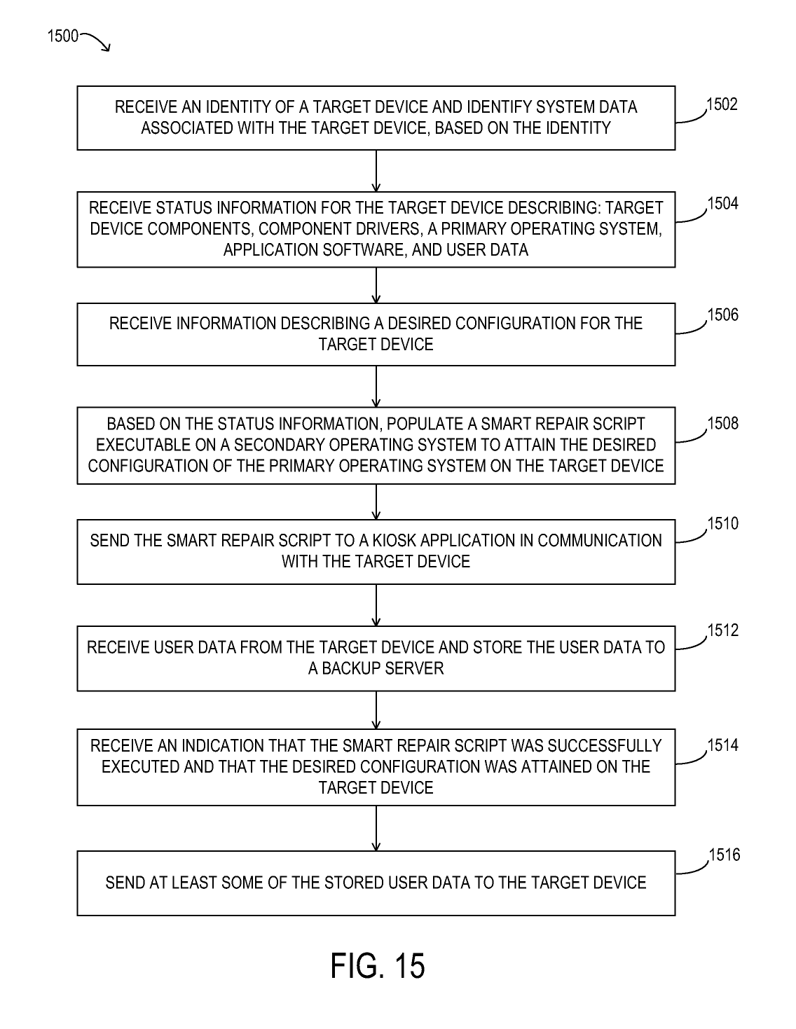

Advancing now to FIG. 15, a diagram of an embodiment of smart repair method 1500 is illustrated in flow chart form. Smart repair method 1500 may be executed by smart repair processing 104 (see FIG. 1). In certain embodiments, smart repair method 1500 is suited for execution by smart repair server 202 (see FIG. 2). It is noted that operations in smart repair method 1500 may be omitted, repeated, or rearranged, as desired.

An identity of a target device may be received, and, based on the identity, system data associated with the target device may be identified (operation 1502). The system data may be identified on a backup server, when backup data for the target device are available. At least some of the system data may be identified by querying an external source using the identity. The identity may be a system tag, a MAC address, a semiconductor device signature, or another type of identifier for the target device. Method 1500 may then receive status information for the target device describing: target device components, component drivers, a primary OS, application software, and user data (operation 1504). Target device status information may be received describing target device components and component drivers associated with the target device. System software status information may be received describing an OS and application software associated with the target device. User data status information may be received describing user data stored on the target device. Information describing a desired configuration for the target device may be received (operation 1506). Based on the status information, a smart repair script, executable on a secondary OS to attain the desired configuration of the primary OS on the target device, may be populated (operation 1508). The smart repair script may be populated with executable commands based on the target device status information, the system software status information, and the user data status information. The smart repair script may be sent to a kiosk application in communication with the target device (operation 1510). The smart repair script may be executed by the kiosk application. In certain embodiments, operation 1510 may be omitted from method 1500, such that the smart repair script is not sent to the kiosk application, but rather, may be executed by a smart repair server application. User data may be receive from the target device and the user data stored to a backup server (operation 1512). Operation 1512 may be performed prior to, or during, execution of the smart repair script. An indication may be received that the smart repair script was successfully executed, and that the desired configuration was attained on the target device (operation 1514). At least some of the user data may be sent to the target device (operation 1516). In certain embodiments, operation 1516 may be integrated into the smart repair script, and be performed prior to operation 1514.

To the maximum extent allowed by law, the scope of the present disclosure is to be determined by the broadest permissible interpretation of the following claims and their equivalents, and shall not be restricted or limited to the specific embodiments described in the foregoing detailed description.

1. A method for performing a smart repair of a target device, comprising:
establishing a communication link with the target device;
analyzing system components included in the target device to generate target device status information;
analyzing system software loaded on the target device to generate system software status information, wherein the system software includes a primary operating system (OS) loaded on the target device;
based on at least one of the target device status information and the system software status information, populating a smart repair script specific to the target device with instructions executable to attain a desired configuration of the target device; and
attaining the desired configuration of the target device by causing the smart repair script to be executed by the target device, wherein the smart repair script is executable under a secondary OS different from the primary OS.

2. The method of claim 1, further comprising:
securing user data stored on the target device, wherein the user data includes data generated by a user of the target device; and
after said attaining the desired configuration of the target device, restoring the user data on the target device.

3. The method of claim 2, wherein said securing the user data is performed via the communication link, and further comprising:
after said restoring the user data, sending a confirmation to the target device that the desired configuration has been successfully attained; and
terminating the communication link.

4. The method of claim 1, wherein said establishing the communication link further comprises:
detecting a connection with the target device;
establishing communication with the target device;
determining an identity of the target device;
based on the identity, authenticating software licenses associated with the target device;
sending target device code to the target device for execution by the target device, wherein the target device code is configured to access storage included in the target device; and
communicating with the target device code executing on the target device.

5. The method of claim 1, wherein said analyzing the system components further comprises:
identifying individual target device system components;
testing the identified target device system components;
evaluating testing results to identify a defective target system component;
identifying component drivers for remediation, wherein remediation includes at least one of: repairing, installing, upgrading, and reinstalling identified component drivers; and
based on said evaluating the testing results and said identifying the component drivers, generating the target device status information usable to populate the smart repair script.

6. The method of claim 1, wherein said analyzing the system software further comprises:
identifying the primary OS installed on the target device, wherein the primary OS includes primary OS data stored on the target device;
testing the primary OS data for a desired primary OS configuration;
based on the result of said testing the primary OS data, identifying primary OS remediation data for attaining the desired primary OS configuration;
identifying application software intended for the target device;
identifying repair data for an existing application program previously installed on the target device;
identifying installation data for a desired application program to be newly installed on the target device;
authenticating a target device software license for the desired application program; and
based on the primary OS remediation data, the repair data, the installation data and said authenticating, generating the system software status information usable to populate the smart repair script.

7. The method of claim 3, wherein said securing the user data further comprises:
identifying the user data stored on the target device;
securing the identified user data by synchronizing the identified user data with backup user data; and
based on the identified user data, generating user data status information usable to populate the smart repair script.

8. The method of claim 7, wherein backup user data are available prior to said securing the user data, further comprising:
determining a difference between the identified user data and the backup user data; and
securing the identified user data based on the difference.

9. The method of claim 1, wherein said populating the smart repair script further comprises:
processing status information usable to populate the smart repair script.

10. The method of claim 1, wherein said executing the smart repair script includes at least one of: remediating target device components, remediating component drivers associated with target device components, remediating an operating system previously installed on the target device, installing a new operating system on the target device, remediating application software previously installed on the target device, and installing new application software on the target device, and
wherein remediating includes at least one of: repairing, installing, upgrading, and reinstalling.

11. The method of claim 10, further comprising:
obtaining system data from an external system software source, wherein system data includes at least one of: component driver data, primary OS data, and application software data.

12. The method of claim 11, wherein the external system software source includes a provider of at least one of: target device components, component drivers, target devices, operating systems, and application software.

13. A smart repair processing system, comprising:
a processor configured to access memory media; and
a network adapter configured to connect to a target device,
wherein the memory media include processor executable instructions to:
connect to the target device via the network adapter;
analyze system components included in the target device;
analyze system software loaded on the target device, wherein the system software includes a primary operating system (OS) loaded on the target device;
receive user input indicative of a desired configuration of the target device; and
attain the desired configuration of the target device, including processor instructions to execute a smart repair script specific to the target device, wherein the smart repair script is executable under a secondary OS on the target device, and wherein the secondary OS is configured to access the primary OS.

14. The smart repair processing system of claim 13, wherein the memory media further include processor executable instructions to:
send code corresponding to the secondary OS to the target device; and
using the code sent to the target device, cause the secondary OS to be loaded on the target device.

15. The smart repair processing system of claim 14, wherein the memory media further include processor executable instructions to:
send a query to the target device to determine whether the secondary OS is loaded on the target device; and
based on a result of the query, send the code corresponding to the secondary OS to the target device.

16. The smart repair processing system of claim 14, wherein the secondary OS is a small footprint OS.

17. The smart repair processing system of claim 13, wherein the memory media further include processor executable instructions to:
prior to executing the smart repair script, secure user data stored on the target device, wherein the user data includes data generated by the user; and
restore the user data on the target device.

18. The smart repair processing system of claim 13, wherein the target device includes a wireless communications device.

19. The smart repair processing system of claim 18, wherein the network adapter is configured to connect to the target device via a wireless network connection.

20. The smart repair processing system of claim 18, wherein the target device is a mobile device.

21. The smart repair processing system of claim 18, wherein the processor and the network adapter are included in a mobile device.

22. The smart repair processing system of claim 13, wherein said processor instructions to analyze the system components further include processor instructions executable to:
identify individual target device system components;
test the identified target device system components;
analyze testing results to identify a defective target system component;
identify component drivers for remediation, including at least one of: repairing, installing, upgrading, and reinstalling said identified component drivers; and
based on the identified defective target system components and the identified component drivers, send, to a smart repair server, target device status information usable to populate the smart repair script.

23. The smart repair processing system of claim 13, wherein said processor instructions to analyze the system software further include processor instructions executable to:
identify the primary OS loaded on the target device, wherein the primary OS includes primary OS data stored on the target device;
test the primary OS data for a desired primary OS configuration;
based on the result of said testing the primary OS data, identify primary OS remediation data for attaining the desired primary OS configuration;
identify application software intended for the target device;
identify repair data for an existing application program previously installed on the target device;
identify installation data for a desired application program to be newly installed on the target device;
validate a target device software license for the desired application program; and
based on the primary OS remediation data, the repair data, the installation data, and the target device software license, send, to a smart repair server, system software status information usable to populate the smart repair script.

24. The smart repair processing system of claim 17, wherein said processor instructions to secure the user data further include processor instructions executable to:
identify the user data stored on the target device;
secure the identified user data by synchronizing the identified user data with backup user data; and
based on the identified user data, send, to a smart repair server, user data status information usable to populate the smart repair script.

25. The smart repair processing system of claim 24, wherein backup user data are available prior to said securing the user data, and wherein the memory media further include processor instructions executable to:
determine a difference between the identified user data and the backup user data; and
secure the identified user data based on the difference.

26. The smart repair processing system of claim 25, wherein the backup user data are secured at a backup server.

27. The smart repair processing system of claim 13, wherein said processor instructions to execute the smart repair script include processor instructions executable to perform at least one of: remediate target device components, remediate component drivers associated with target device components, remediate an operating system previously installed on the target device, install a new operating system on the target device, remediate application software previously installed on the target device, and install new application software on the target device, and
wherein said processor instructions to remediate include processor instructions to perform at least one of: repairing, install, upgrade, and reinstall.

28. The smart repair processing system of claim 13, wherein the memory media further include processor instructions executable to:
receive the smart repair script from a smart repair server.

29. The smart repair processing system of claim 13, further comprising the memory media.

30. Computer-readable memory media, including executable instructions for smart repair processing, said instructions executable to:
in response to receiving an identity of a target device, identify system data associated with the target device;
receive target device status information describing target device components and component drivers associated with the target device;
receive system software status information describing a primary operating system (OS) and application software associated with the target device;
receive information describing a desired configuration for the target device; and
based on at least one of the target device status information and the system software status information, populate a smart repair script executable to attain the desired configuration, wherein the smart repair script is executable under a secondary OS different from the primary OS.

31. The memory media of claim 30, further comprising instructions executable to:
receive user data status information describing user data stored on the target device, wherein the user data includes data generated by a user of the target device.

32. The memory media of claim 30, wherein the smart repair script further includes logical elements configured for conditional execution on the target device wherein the logical elements include at least one of: logical evaluations, logical dependencies, test routines for the target device and associated test results, arithmetic evaluations, comparisons, execution branches, and execution loops.

33. The memory media of claim 30, further comprising instructions executable to: execute the smart repair script on a second target device to attain the desired configuration on the second target device.

34. The memory media of claim 30, further comprising instructions executable to:
receive an indication that the smart repair script was executed, including receiving an execution report for the executed smart repair script.

35. The memory media of claim 34, wherein the execution report indicates that the smart repair script was successfully executed and that the desired configuration was attained on the target device.

36. The memory media of claim 30, further comprising instructions executable to:
receive user data from the target device;
store the user data to a backup server; and
after the smart repair script is executed on the target device, send at least a portion of the stored user data to the target device.

37. The memory media of claim 30, further comprising instructions executable to:
execute the smart repair script using the secondary OS.

38. The memory media of claim 30, further comprising instructions executable to:
send the smart repair script to a kiosk application in communication with the target device.

39. The memory media of claim 30, further comprising instructions executable to:
in response to receiving a request for system data for the target device, obtain the requested system data from an external system software source, wherein system data includes at least one of: component driver data, operating system data, and application software data; and
send the requested system data to the target device.

40. The memory media of claim 39, wherein the external system software source includes a provider of at least one of: target device components, component drivers, target devices, OSs, and application software.

41. The memory media of claim 30, wherein said information describing the desired configuration includes an indication of system software for installation on the target device.

42. The memory media of claim 41, wherein the indicated system software includes a newly installed application software on the target device.

43. The memory media of claim 30, further comprising instructions executable to:
receive user data from the target device;
receive system data from the target device; and
store the user data and the system data on a backup server.
